(19) United States
(12) Patent Application Publication
(10) Pub. No.: US 2011/0251000 A1
(43) Pub. Date: Oct. 13, 2011

(54) ENDLESS TRACTION MECHANISM TENSIONER

(75) Inventors: Petrus Hubertus Kroon, Furth (DE); Christian Hartmann, Nemsdorf (DE)

(73) Assignee: SCHAEFFLER TECHNOLOGIES GMBH & CO. KG, Herzogenaurach (DE)

(21) Appl. No.: 13/084,836

(22) Filed: Apr. 12, 2011

(30) Foreign Application Priority Data
Apr. 13, 2010 (DE) 102010014735.4

(51) Int. Cl. F16H 7/08

(52) U.S. Cl. 474/110

(57) ABSTRACT

A tensioning device for an endless traction mechanism for a motor is provided and includes a housing (1) that has a cylinder chamber (9) for holding hydraulic fluid, a piston (2) that is supported so that it can slide in the cylinder chamber (9) and is biased by a spring (3), and a valve (4) that is arranged on the base (10) of the housing (1) and connects the cylinder chamber (9) to an oil supply space (8) . In the base (10) of the housing (1), there is at least one groove (5) that allows a ventilation of the cylinder chamber (9).

### CROSS-REFERENCE TO RELATED APPLICATIONS

This application claims the benefit of German Patent Application No. 10 2010 014 735.4, filed Apr. 13, 2010, which is incorporated herein by reference as if fully set forth.

### BACKGROUND

The invention relates to an endless traction mechanism tensioner for an endless traction mechanism of an internal combustion engine.

In a force-transmission mechanism that is configured to transmit the rotational movement of a crankshaft via an endless traction mechanism, such as, e.g., a chain, to one or more camshafts or other assemblies of an internal combustion engine of a motor vehicle, the tensioning of the endless traction mechanism is held constant in that a tensioning device is provided that exerts a tensioning force on the endless traction mechanism. This tensioning force that is transmitted by a piston of the tensioning device to the endless traction mechanism could be provided, for example, by a cylindrical compression spring. In the case of sagging of the endless traction mechanism, the piston biased by the compression spring moves forward, in order to exert a pressure on the endless traction mechanism, so that the endless traction mechanism again contacts, with the necessary tension, the driving and driven disks of the crankshaft or the camshafts or the assemblies and cannot jump out. Furthermore, the cylinder chamber of the tensioning device in which the piston is guided could be pressurized with a pressure medium, so that the tension of the endless traction mechanism can be controlled by changing the tensioning force exerted by the piston and the backward movement of the piston is damped with the help of a hydraulic oil fed behind the piston. The hydraulic oil is fed via a non-return valve from the oil supply space into the cylinder chamber.

A known problem of endless traction mechanism tensioners according to the prior art is that overhead insertion, that is, with the piston directed downward, leads to degraded damping behavior. This degradation is triggered by air that collects at the highest point of the endless traction mechanism tensioner due to its lower density. In the case of overhead-inserted tensioning devices, this highest point is usually the valve that connects the cylinder space to the oil supply space. Through the collection of air in the cylinder space, it can happen that the endless traction mechanism tensioner can no longer apply sufficient force, in order to hold the endless traction mechanism completely in tension, resulting in rattling.

For solving this problem, a special non-return valve is described in EP 1 602 857 A2 that allows ventilation of the endless traction mechanism tensioner by a special geometry of the valve. In the valve, channels are provided through which the air can escape into the oil supply space. This invention does indeed solve the known problem, but the valves according to the invention must be redesigned and manufactured for all of the different sizes of endless traction mechanism tensioners, which results in considerable complexity and thus associated costs.

### SUMMARY

The invention is therefore based on the objective of providing a simple and cost-effective tensioning device for an endless traction mechanism in which possibly present air can escape independent of the installation arrangement.

This objective is met with the tensioning device according to the invention. Preferred constructions of the invention are to be taken from the subordinate claims, the figures, and the associated description.

According to the invention, at least one groove is provided in the base of the housing, with this groove allowing ventilation of the cylinder chamber. Through this ventilation possibility, it is avoided that air can collect in the cylinder chamber. Thus, the tensioning device can keep the endless traction mechanism constantly in tension and rattling is counteracted. In addition, a realization of one or more grooves in the base of the housing is very simple. Several grooves could be produced in the component without a problem in a step with deep-drawing and/or extrusion of the housing. In this way, the grooves can be realized very easily and economically in the base of the housing. Optionally, the grooves could also be milled into the housing completely automatically.

Advantageously, a defined leakage gap A with a leakage rate made possible in this way can be realized by one or more grooves together with the associated groove depths. Because the grooves can be produced very precisely, it is possible to define the leakage rate and thus also the damping properties by the groove depth. The leakage gap length is therefore constant and not dependent on the position of the piston in the housing; the leakage gap length is consequently stroke-independent. A stroke-independent damping behavior is advantageous, in principle, and, in addition, the oil consumption of the tensioning device can be reduced, because the hydraulic oil is led back into the oil supply space. The construction according to the invention can also be transferred to already existing tensioning devices and thus can be inserted overhead according to the invention.

Advantageously, the inner diameter of the housing in the region of the valve is selected so that a defined leakage gap B is set between the valve and the inner wall of the housing. In addition to the construction of the housing base according to the invention and described in the preceding paragraph, the gap between the inside of the housing and the valve can also be used actively for realizing a leakage gap, without any special geometries having to be provided on the inside of the housing or the valve body. According to requirements, leakage gap A or leakage gap B could essentially define the damping properties of the tensioning device or advantageously the damping properties are significantly influenced by both leakage gaps jointly. According to requirements, different leakage gap lengths and leakage rates could be provided. Through this setting possibility of the leakage gap or its geometry, the damping of the tensioning devices could be improved and thus the operating behavior of the tensioning devices could be optimized. For future applications, this means better adjustability for each motor.

Advantageously, the grooves according to the invention are arranged equidistant in the base of the housing on an imaginary circular path. Through such an arrangement of the grooves, the defined leakage gap A has an especially advantageous construction, because in this way the air and the hydraulic oil can flow uniformly and thus an especially good damping behavior can be achieved by especially homogeneous pressure and tension states in the tensioning device.

Advantageously, in the base of the housing, an annular groove is provided into which the grooves open. The advantage of such an annular groove is that air and hydraulic fluid, after it has passed the leakage gap B, is collected in the annular groove and then can be distributed uniformly to all grooves that form the leakage gap A. In this way it is achieved that hydraulic fluid and air can flow out subsequent to the annular groove uniformly through the leakage gap A into the oil supply space.

### BRIEF DESCRIPTION OF THE DRAWINGS

Below, the invention will be explained in detail with reference to several figures. To be seen, in detail, in the figures are:

FIG. 1: a perspective diagram of a tensioning device according to the invention; and

FIG. 2: an enlarged perspective diagram of the section 7 from FIG. 1.

### DETAILED DESCRIPTION OF THE PREFERRED EMBODIMENTS

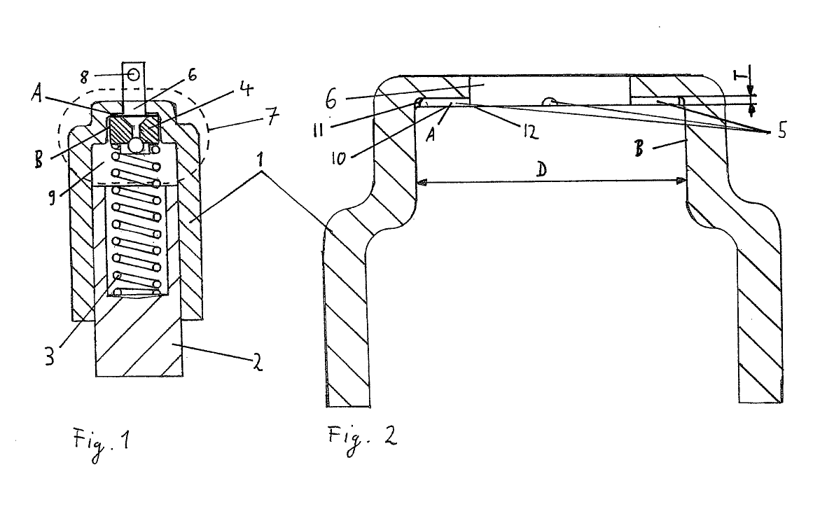

In FIG. 1, a tensioning device according to the invention is SHOWN that comprises a housing 1 that has a cylinder chamber 9 for holding hydraulic fluid, a piston 2 that is supported so that it slides in the cylinder chamber 9 and is biased by a spring 3, and a valve 4 that is arranged at an opening 6 in the base 10 of the housing 1 and connects the cylinder chamber 9 to an oil supply space 8. The one end of the spring 3 contacts the piston 2; the other end contacts the valve 4. Therefore, the valve 4 is pressed against the base 10 of the housing 1. The base 10 therefore forms a sealing surface 12 for the valve 4. The valve 4 is made from a closure body that has a valve opening that can be closed by a spring-loaded valve body. Four grooves 5 that are shown in the enlarged diagram of region 7 in FIG. 2 are provided on the base 10 of the housing 1 (one of the four grooves 5 is not visible due to the perspective diagram); these grooves 5 break up the sealing surface 12 in a targeted way and open into an annular groove 11. In this embodiment, the grooves 5 are arranged equidistant at an angle of 90° relative to each other on an imaginary circular path, so that the defined leakage gap A realized by the grooves 5 is especially symmetric and therefore the damping behavior can be set in an especially precise way, because in this way a uniformly regulated return flow of air and hydraulic oil into the oil supply space 8 is achieved. The diameter D designates the inner diameter of the housing 1 in the region of the valve 4. Between valve 4 and inner wall of the housing 1, a leakage gap B is constructed that can be set exactly by adapting the diameter. In the case of overhead installation of the tensioning device, air and hydraulic oil flow first through the leakage gap B, then through the leakage gap A, and reach the oil supply space 8 after passing the opening 6. In this way, the hydraulic fluid is fed back to the oil circuit and the oil consumption of the tensioning device is reduced overall. The groove depth T here plays a large role, because it directly influences the leakage volume and thus the damping properties of the tensioning device. The two leakage gaps A and B can each have especially large or small effects on the damping properties of the tensioning device according to the construction of the diameter D and the groove depth T, and thus can significantly influence the damping properties of the endless traction mechanism tensioner individually or in sum. In each case, they allow ventilation of the cylinder chamber 9 through an exact and stroke-independent setting of the leakage rates and thus improve the damping properties of the tensioning device. The grooves 5 could also be implemented easily and economically, in that they are realized, for example, without post-processing, in a deep-drawing and/or extrusion method for production of the housing 1.

### LIST OF REFERENCE SYMBOLS

1 Housing

2 Piston

3 Spring

4 Valve

5 Groove

6 Opening

7 Region

8 Oil-supply space

9 Cylinder chamber

10 Base

11 Annular groove

12 Sealing surface

A Leakage gap

B Leakage gap

D Diameter

T Groove depth

1. A tensioning device for an endless traction mechanism in a motor, the tensioning device comprising:
a housing (1) that has a cylindrical chamber (9) for holding hydraulic fluid,
a piston (2) that is supported for sliding movement in the cylinder chamber (9) and is biased by a spring (3), and
a valve (4) that is arranged on a base (10) of the housing (1) and connects the cylinder chamber (9) to an oil supply space (8), and
at least one groove (5) that allows a ventilation of the cylinder chamber (9) located in the base (10) of the housing (1).

2. The tensioning device according to claim 1, wherein a defined leakage gap A that essentially defines a damping behavior of the tensioning device is formed by the at least one groove (5).

3. The tensioning device according to claim 1, wherein an inner diameter (D) of the housing (1) in a region of the valve (4) is selected so that, between the valve (4) and an inner wall of the housing (1), a defined leakage gap B is set by which a damping behavior of the tensioning device is essentially defined.

4. The tensioning device according to claim 2, wherein the damping behavior of the tensioning device is defined essentially by the leakage gap A and a leakage gap B that is defined between an inner diameter (D) of the housing (1) in a region of the valve (4) and the valve (4).

5. The tensioning device according to claim 1, wherein there are several of the grooves (5) directed in a radial direction and the grooves (5) are arranged equidistant on an imaginary circular path.

6. The tensioning device according to claim 5, wherein four of the grooves are arranged on the imaginary circular path at intervals of 90°.

7. The tensioning device according to claim 5, wherein an annular groove (11) is located in the base (10) of the housing (1) into which the grooves (5) open.

8. The tensioning device according to claim 1, wherein the at least one groove (5) is arranged in a sealing surface (12) arranged on the base (10).

9. The tensioning device according to claim 8, wherein the valve (4) has a closure body that contacts the sealing surface (12) and has a valve opening that can be closed by a spring-loaded valve body.

10. The tensioning device according to claim 1, wherein the housing (1) is a deep-drawn or extruded housing.
